(19) United States
(12) Patent Application Publication
(10) Pub. No.: US 2026/0054400 A1
(43) Pub. Date: Feb. 26, 2026

(54) ELECTRIC HAIR TRIMMER

(71) Applicant: Braun GmbH, Kronberg (DE)

(72) Inventors: Gerd LASCHINSKI, Bad Homburg (DE); Markus SCHUESSLER, Koenigstein (DE); Ruediger BOSS, Frankfurt (DE); Philipp GOEDER, Frankfurt (DE); Detlef GLEICH, Friedrichsdorf (DE)

(21) Appl. No.: 19/305,861

(22) Filed: Aug. 21, 2025

(30) Foreign Application Priority Data
Aug. 21, 2024 (EP) 24195689.5

(51) Int. Cl. B26B 19/06; B26B 19/04; B26B 19/38

(52) U.S. Cl. CPC B26B 19/063; B26B 19/042; B26B 19/3846; B26B 19/3853

(57) ABSTRACT

The present invention relates to a cutter head for an intimate trimmer, comprising a cutter head frame attachable to an elongated handle, a pair of cooperating cutter blades each having at least one row of comb-like cutting teeth for long hair cutting and movable relative to each other, and a shear foil system with at least one field of perforations for short hair cutting arranged on a rear or trailing side of said at least one row of comb-like cutting teeth, and furthermore, a protective attachment for protecting skin from being cut by said comb-like cutting teeth, wherein said protective attachment includes a row of comb-like protective teeth, wherein said cutting teeth for long hair cutting are arranged in a countersunk position below a virtual tangential plane onto said shear foil system and said comb-like protective teeth of said protective attachment.

### FIELD OF THE INVENTION

The present invention relates to cutting body hair such as intimate hair cutting or body hair grooming in sensitive skin areas. More particularly, the present invention relates to a cutter head for an intimate trimmer or body groomer, comprising a cutter head frame attachable to an elongated handle, a pair of cooperating cutter blades each having at least one row of comb-like cutting teeth for long hair cutting and movable relative to each other, and a shear foil system with at least one field of perforations for short hair cutting arranged on a rear or trailing side of said at least one row of comb-like cutting teeth, and furthermore, a protective attachment for protecting skin from being cut by said comb-like cutting teeth. The invention also relates to a hair cutter such as an intimate trimmer or body groomer, comprising an elongated handle and such cutter head attached to an end portion of said elongated handle.

### BACKGROUND OF THE INVENTION

Electric shavers and trimmers utilize various mechanisms to provide hair cutting functionality. Some electric shavers include a perforated shear foil cooperating with an undercutter movable relative thereto so as to cut hairs entering the perforations in the shear foil. Such shear foil type shavers are often used on a daily basis to provide for a clean shave wherein short beard stubbles are cut immediately at the skin surface.

On the other hand, other cutter systems including a pair of cooperating comb-like cutting elements with a plurality of comb-like or rake-like cutting teeth reciprocating or rotating relative to each other, are often used for cutting longer beard stubbles or curled body hair in intimate body regions or more generally, body hair being too long for shaving with a shear foil system. The teeth of such comb-like or rake-like cutting elements usually project substantially parallel to each other or substantially radially, depending on the type of driving motion, and may cut hairs entering into the gaps between the cutting teeth, wherein cutting or shearing is achieved in a scissor-like way when the cutting teeth of the cooperating elements close the gap between the finger-like cutting teeth and pass over each other.

Such cutter systems for longer hairs may be integrated into electric groomers or trimmers which at the same time may be provided with the aforementioned shear foil cutters. For example, there are electric trimmers or styling apparatus which are provided with a pair of such comb-like cutting elements spaced apart from each other and facing away from each other with a shear foil system arranged between said pair of rake-like cutting elements, cf. EP 41 19 313 A1. In the alternative, only one row of such comb-like cutting elements may be provided and accompanied by a shear foil system arranged on a trailing side thereof.

In such combined trimmers or groomers, the different cutter systems may provide for a two-step hair cutting action in one stroke, wherein the rake-like cutting elements, in a first cutting step, cut longer hairs and in a second step, the shear foil system cuts the stubbles remaining after the first step. Such two-step cutting can be achieved in a single move as the shear foil system is positioned on a rear side or trailing side of the long hair cutter so, when moving the cutter head over the skin in a direction substantially perpendicular to the extension of the row of rake-like cutting teeth, the shear foil system follows the comb-like cutting elements and shaves the skin areas which just have been passed by the comb-like cutting teeth. Thus, the rake-like cutting teeth form a pre-cutter unit and the shear foil system forms a final or subsequent cutter unit or post-cutter unit.

So as to achieve efficient cutting by the shear foil system, the hair stubbles left by the rake-like cutter elements, need to be short enough to find their way into the perforations of the shear foil cutter, wherein preferably such length of the remaining hair stubbles should be less than 1 mm. However, so as to cut long hairs such short, the user needs to move the cutter head, with the rake-like cutting elements, over the skin very closely thereto what poses the risk that the sharp, rake-like cutter elements interfere with the skin and generate irritations, small cuts and similar mikro-injuries. Such risk is increased when using the hair cutter in sensitive skin regions such as a human's intimate regions where the skin is very soft and tends to easily bulge and thus, getting caught by the sharp tips of the rake-like cutting elements. Such problem of skin wrapping around the tooth tips of the rake-like cutting elements may cause skin irritations and skin injuries even when the upper one of the cooperating cutter blades is kept stationary, wherein such problem is aggravated by cutter systems having driven, e.g. reciprocating upper cutter blades.

So as to keep the cutting elements away from the skin at a certain distance therefrom, a distance comb may be attached to the cutter head, wherein such distance comb may include a plurality of ribs that may extend substantially parallel to a preferred or natural direction of movement of the cutter head over the skin. For example, for the aforementioned rake-like cutting elements for cutting longer hairs in a scissor-like way, the ribs of the distance comb may be oriented perpendicular to the row of teeth of such rake-like cutting elements, cf. EP 3 131 711 B1. Such distance combs may be used to control the length of the hair remaining on the skin after cutting, wherein, e.g., a distance comb with ribs defining a skin contact surface 3 mm away from the rake-like cutting elements may be used for achieving a haircut leaving hairs of 3 mm length on the skin. On the other hand, such distance combs are also used for protecting sensitive skin against irritations such as nicks, cuts or abrasion when the hair cutter is used by less experienced users.

For example, such distance comb is a helpful protector when using the hair cutter to cut hair in intimate regions of a body having very soft and sensitive skin that tends to easily get into the cutting elements.

Such protective attachments as known from EP 3 131 711 B1, however, are not satisfying for combined cutter systems including both rake-like cutter elements and a shear foil cutter for effecting the aforementioned two-step cutting action, because the protective ribs tend to keep the skin away not only from the rake-like cutter elements, but also from the shear foil so the short hair stubbles which were left in the first cutting step, may not enter into the perforations of the shear foil. Furthermore, such protective attachments tend to keep the rake-like cutting elements too far away from the skin so, even when the shear foil cutter may contact the skin, the hair stubbles left by the rake-like cutter elements may not find their way into the perforations of the shear foil because of being still too long.

### SUMMARY OF THE INVENTION

It is an objective underlying the present invention to provide for an improved hair cutter allowing for improved intimate hair cutting or body hair grooming in sensitive skin areas. More particularly, it is desired to achieve efficient body hair grooming or intimate hair cutting with only one stroke of the cutter head along the skin without sacrificing skin protection and safety against skin irritations or skin injuries.

Another objective of the present invention is to provide for an improved protective attachment allowing the rake-like cutter elements come close enough to the skin to leave hair stubbles short enough for the following shear foil system but still keep sensitive and soft skin that may casily bulge, reliably away from the tooth tips of the rake-like cutter elements.

A still further objective underlying the invention is to create an efficient, easy-to-use body hair groomer or intimate hair cutter achieving clean long hair cutting with one stroke along the skin only without sacrificing skin protection.

To achieve at least one of the aforementioned objectives, it is suggested to provide for a cutter head having a protective attachment partly forming the skin contact surface of the cutter head such that the rake-like cutting teeth of the cooperating cutter blades are slightly recessed from the skin contact surface and, on the other hand, the shear foil system may solidly contact the skin to ensure efficient short hair cutting of the hair stubbles left by the cooperating cutter blades. More particularly, the protective attachment may include a row of comb-like protective teeth arranged on a front side of said cutting teeth for long hair cutting opposite to the shear foil system on the rear or trailing side thereof, wherein said cutting teeth for long hair cutting are arranged in a countersunk position below level of elevation of said protective teeth. More particularly, when considering a virtual plane defined by contacting the shear foil system and the countersunk cutting teeth, the protective teeth are elevated and projecting beyond such virtual plane. Furthermore, when considering another virtual plane lying on said protective teeth and parallel to the aforementioned plane contacting the shear foil system and the cutting teeth, the cutting teeth are in countersunk position below such further virtual plane lying on the protective teeth.

Thus, the skin over which the cutter head is moved in a cutting stroke, is guided over the tooth tips of the cutting teeth in a bridge-like manner, wherein the protective teeth of the protective attachment on the front side of the cutting teeth and the shear foil system on the rear side of the cutting teeth form a sort of bridge abutment. Due to the countersunk position of the cutting teeth on a rear side of the protective teeth, the skin is reliably prevented from wrapping around the tooth tips even when bulging towards the cutter head between said protective teeth and the shear foil system.

Advantageously, said row of protective teeth and the shear foil system may together form parts of the skin contact surface of the cutter head, wherein said skin contact surface provides for a depression for skin bulging between said row of protective teeth and said shear foil system, wherein said row of cutting teeth for long hair cutting is arranged in said depression. Such arrangement of the cutting teeth in a depression of the skin contact surface of the cutter head allows the skin to bulge towards the cutter head and thus ensures solid skin contact to the shear foil system and still prevents the skin from wrapping around the tooth tips. When considering a stroke of the cutter head over a skin portion, the skin is allowed to bulge towards the cutter head to some extent behind the comb-like cutting teeth, i.e. after having passed the protective teeth and the cutting teeth to make sure the left stubbles may enter into the perforations of the shear foil system, whereas the countersunk positioning of the cutting teeth prevents the skin from wrapping around the tooth tips.

The offset of the cutting teeth from the aforementioned plane lying on the protective teeth into said countersunk position may be rather small and may be adapted to the size of the perforations of the shear foil system. More particularly, said offset into the countersunk position may substantially correspond to or may be slightly smaller than the diameter of the perforations so as to, on the one hand, make the left hair stubbles reliably find their way into the perforations of the shear foil system and, on the other hand, keep the skin away from the tooth tips of the rake-like cutter element by a sufficient distance to avoid skin irritations and skin injuries.

For example, the offset of the rake-like cutter elements from said plane lying on the protective teeth may range from 33% to 100% or 50% to 95% of the diameter of the perforations of said shear foil system. Such offset distance may range from, e.g., 0.1 to 0.6 mm or from 0.3 to 0.5 mm.

These and other advantages become more apparent from the following description giving reference to the drawings and possible examples.

### BRIEF DESCRIPTION OF THE DRAWINGS

FIG. 1: a perspective view of an intimate hair trimmer with a protective attachment attached to the cutter head of the trimmer,

FIG. 2: a perspective view of the cutter head and the attached protective attachment removed from the handle of the hair trimmer,

FIG. 3: a perspective view of the cutter head without protective attachment, to show the cutter head's cutter system including two rows of rake-like cutting teeth and a shear foil cutter system positioned between said two rows of cutting teeth,

FIG. 4: a perspective view of the protective attachment showing two rows of protective teeth on opposite sides of an attachment frame,

FIG. 5: a perspective view of the cutter head in a view similar to FIG. 3, but the protective attachment of FIG. 4 being attached to the cutter head,

FIG. 6: a front view of the cutter head with the protective attachment attached thereto,

FIG. 7: a cross-sectional view of the cutter head and the protective attachment along the line A-A in FIG. 6,

FIG. 8: an enlarged cross-sectional view of the cutter head and more particularly, the part of the cutter head marked by the hatched circle B in FIG. 7,

FIG. 9: an enlarged, partial cross-sectional view of the cutter head and the mounted protective attachment in a view similar to FIG. 8, wherein two virtual tangential planes are shown to illustrate the positioning of the rake-like cutting teeth and the contour of the skin contact surface of the cutter head,

FIG. 10: a side view of a protective tooth of the protective attachment in a partial view to illustrate the rounded contour of the protective tooth at an edge facing away from the rake-like cutting teeth,

FIG. 11: a plane top view of the cutter head illustrating the positioning of the rows of protective teeth in front of the rows of cutting teeth and the entirely free axes to the shear foil system, and

FIG. 12: a side view of a protective tooth of the protective attachment in partial view to illustrate inclined skin contacting surface on the top side of the tooth.

### DETAILED DESCRIPTION OF THE INVENTION

So as to allow the comb-like cutter elements come close enough to the skin to leave hair stubbles short enough for the following shear foil system, but still keep bulging soft skin reliably away from the tooth tips of the rake-like cutter elements, the cutter head may be provided with a protective attachment partly forming the skin contact surface of the cutter head such that the rake-like cutting teeth are slightly recessed from the skin contact surface formed by the protective attachment.

More particularly, the protective attachment may include a row of comb-like protective teeth arranged along a front side of said cutting teeth opposite to the shear foil system on the rear or trailing side thereof, wherein said comb-like cutting teeth are arranged in a countersunk position below a plane lying on the protective teeth and parallel to a virtual plane contacting the shear foil system and the comb-like protective teeth of the protective attachment. Such virtual plane may have a contact line or contact point on each of said shear foil system and row of protective teeth. Thus, the skin over which the cutter head stroked is guided in a bridge-like manner to sort of flow or glide over the tooth tips of the cutting teeth, wherein the protective teeth of the protective attachment on the front side of the cutting teeth and the shear foil system on the rear side of the cutting teeth form a sort of bridge abutment. Due to the countersunk position of the cutting teeth on a rear side of the protective teeth, the skin is reliably prevented from wrapping around the tooth tips even when bulging towards the cutter head between said protective teeth and the shear foil system.

Advantageously, said row of protective teeth and the shear foil system may together form parts of the skin contact surface of the cutter head, wherein said skin contact surface may have a depression or deepening's for skin bulging between said row of protective teeth and said shear foil system, wherein said row of cutting teeth for long hair cutting is arranged in said depression. Such arrangement of the cutting teeth in a depression of the skin contact surface of the cutter head allows the skin to bulge towards the cutter head and thus, ensures solid skin contact to the shear foil system and still prevents the skin from wrapping around the tooth tips.

When considering a stroke of the cutter head over a skin portion, which stroke may have a direction substantially perpendicular to the longitudinal extension of the row of cutting teeth with the cutting teeth going ahead, the skin is allowed to bulge towards the cutter head to some extent behind the comb-like cutting teeth, i.e. after having passed the protective teeth and the cutting teeth, so the skin may solidly contact the following shear foil system and thus, the left stubbles may reliably enter into the perforations of the shear foil system, whereas the countersunk positioning of the cutting teeth prevents the skin from wrapping around the tooth tips.

The offset of the cutting teeth from the aforementioned plane, which plane is lying on the protective teeth and is parallel to the virtual plane contacting the cutting teeth and the shear foil system, into said countersunk position may be rather small and may be adapted to the size of the perforations of the shear foil system. More particularly, said offset into the countersunk position may substantially correspond to or may be slightly smaller than the diameter of the perforations so as to, on the one hand, make the left hair stubbles reliably find their way into the perforations of the shear foil system and, on the other hand, keep the skin away from the tooth tips of the rake-like cutter element by a sufficient distance to avoid skin irritations and skin injuries.

For example, the offset of the rake-like cutter elements from said virtual plane lying on the protective teeth may range from 25% to 125% or from 33% to 100% or from 50% to 95% or from 66% to 95% or from 75% to 95% of the diameter of the perforations of said shear foil system.

For example, such offset distance may range from, e.g., 0.1 to 0.6 mm or from 0.3 to 0.5 mm.

The perforations of the shear foil of the shear foil system may have a diameter or maximum width of about 0.4 to 0.6 mm or about 0.5 mm.

So as to allow hairs to reliably enter the channel-like recesses between the cutting teeth despite the protective teeth of the protective attachment being positioned, when considering the direction of a stroke of the cutter head over the skin, in front of the cutting teeth, the number of protective teeth of the protective attachment may be smaller than the number of the cutting teeth to provide for additional space between the protective teeth and to make it easy for the hairs to pass the protective teeth.

More particularly, the number of protective teeth may range from only 20% to 80% or 25% to 50% of the number of cutting teeth. Due to such reduced number of protective teeth, there are less obstacles in front of the row of cutting teeth to be passed by the hair to be cut. In other words, the protective attachment, despite its protective teeth positioned in front of the cutting teeth, does not block the cutting teeth and more particularly does not prevent hair from entering into the gaps between the cutting teeth. Nevertheless, such reduced number of protective teeth may suffice to prevent the skin from wrapping around the tooth tips.

So as to further reduce such blocking effect and to keep the entering channels free from obstacles, the arrangement of the protective teeth of the protective attachment may have a toothing pitch that is an integer multiple of the toothing pitch of the cutting teeth.

More particularly, the protective teeth may be arranged such that a protective tooth is arranged in front of every second or every third or every fourth stationary cutting tooth of the rake-like cutting teeth of the cooperating cutter blades. Such alignment of the protective teeth with the stationary teeth of the stationary cutter blade maximizes the width of the channels for the hairs entering into the gaps between the cutting teeth and thus minimizes the likelihood of hairs flexing away from the cutting edges of the cutting teeth and thus, of hairs being blocked from entering into the cutting zones of the coopering cutter blades.

So as to allow the shear foil system efficiently cut the hair stubbles left by the cooperating cutter blades and thus, to allow clean hair cutting by only one stroke, the protective attachment may be formed exclusively outside a central cutter head region in which at least said shear foil system is positioned so as to allow the skin solid contact to the shear foil system. In particular, the protective attachment does not include any protective ribs extending over the shear foil system.

More generally, when considering a viewing direction perpendicular onto the cutter head's skin contact surface, at least the shear foil system is left entirely unobstructed by the protective attachment.

More particularly, said central cutter head region left unobstructed by the protective attachment may be a bit larger than the outline of the shear foil cutter system. More particularly, the protective attachment may be formed exclusively outside a central cutter head region comprising the shear foil system plus the at least one row of cutting teeth or, when a pair of rows of cutting teeth are provided, said shear foil system plus said two rows of cutting teeth.

According to a further aspect, a skin contact bracket may be provided between the shear foil system and said at least one row of cutting teeth, wherein a deepening may be provided between said skin contact bracket and said shear foil system and/or a deepening may be provided between said skin contact bracket and said row of cutting teeth. Such skin contact bracket may have a rib-like, elongated contour and may extend along a rear side of the cutting teeth.

For example, on both sides of said skin contact bracket which may extend along an edge portion of the shear foil system, elongated, groove-like or chamfered depressions may be provided. Such skin contact bracket between the shear foil system and the neighboring or adjacent row of cutting teeth may form another sort of bridge abutment guiding the skin over the rake-like cutting teeth even when soft skin is bulging toward the cutter head. More particularly, the skin contact surface may form a sort of stopper to bulging skin and shortens the distance of free skin bulging between the protective teeth of the attachment on the one hand and the shear foil system's surface on the other hand.

Such skin contact surface may form a part of the skin contact surface of the cutter head, wherein such part of the skin contact surface formed by the skin contact bracket may be formed parallel to or adjacent to said virtual plane contacting the shear foil system on the one hand and said row of cutting teeth on the other hand. For example, the skin contacting surface of said skin contact bracket may lie in or almost lie in said virtual plane contacting the shear foil system and the cutting teeth, wherein such skin contacting surface may be substantially plane or slightly convex or concave. When having a curved contour, such curved contour may be substantially tangential to said virtual plane contacting the shear foil system and said cutting teeth.

Thus, said skin contact bracket prevents the skin from bulging deeper than the upper surface of the cutting teeth. Since the protective teeth of the protective attachment on the other side of the cutting teeth is elevated with regard to the upper surface of the cutting teeth, the skin contact bracket having a surface tangential to a plane touching the upper surface of the cutting teeth on the one hand and the shear foil system on the other hand, effectively prevents the skin from touching the cutting teeth and on the other hand, allows for closeness of the cutting teeth to the skin to cut long hair sufficiently short.

Said skin contact bracket may have a skin contact surface that is substantially planar and inclined such that it is substantially parallel to the aforementioned virtual tangential plane contacting the shear foil and the cutting teeth.

On the other hand, the protective teeth of the protective attachment also may have a substantially planar top end surface which may be oriented substantially parallel to said aforementioned virtual tangential plane defined by contact to the shear foil system and the row of cutting teeth.

So as to allow smooth gliding or sliding over the skin, the protective teeth of the attachment may have an outer edge that is rounded. Such outer edge may be the protective teeth edge that is facing away from the row of cutting teeth. More particularly, when considering the direction of a stroke of the cutter head moving the protective teeth over the skin in front of the rake-like cutting teeth, said rounded edge may be the front edge of the protective teeth.

Said rounded front edge of the protective teeth of the protective attachment may connect tooth flanks which are inclined to each other at an acute angle which acute angle may range from about 60° to 90° or from 70° to 89° or from 75° to 85°. Such acute angle helps in combining a slim, compact size of the protective teeth with smooth sliding of the protective attachment over the skin. Such slim, compact size helps in making hairs reliably and directly enter into the gaps between the rake-like cutting teeth.

Both of said cooperating cutter blades having said rake-like cutting teeth may be movable to be driven by a drive unit, wherein it may be advantageous to have one stationary cutter blade and one driven cutter blade. For example, an upper cutter blade that is closer to the skin than a lower cutter blade may be stationary and the lower cutter blade may be driven in a, for example, reciprocating linear or rotatory way. On the other hand, according to an aspect, it may be the upper cutter blade that is driven, whereas the lower cutter blade further away from the skin may be stationary. Due to the highly efficient protection of the protective attachment, it is possible to have the upper cutter blade reciprocate without sacrificing skin protection.

So as to allow for safe use by unexperienced users as well as for maximum performance for skilled users, the protective attachment may be releasably attached to or snap fitted with said cutter head frame with the cutter head. Releasable attachment elements of the protective attachment also allow for easy cleaning.

As mentioned, the cutter head may have only one row of rake-like cutting teeth. On the other hand, so as to allow for stroking the cutter head over the skin in two opposite directions, the cutter head may be provided with two rows of rake-like cutting teeth which may be facing away from each other and spaced apart from each other with the shear foil system being positioned between said two rows of cutting teeth.

Irrespective of the number of rows of cutting teeth, the protective attachment may have a substantially ring-shaped configuration, wherein the protective attachment may include a ring-shaped attachment frame which may be provided with two rows of protective teeth along opposite frame legs. Even when using the attachment in combination with a cutter head only having one row of rake-like cutting teeth, it is useful to have a protective attachment having two rows of protective teeth to prevent beginners from attaching the protective attachment in a wrong orientation and to not need attachment keys allowing for attachment in only one orientation. At the same time, the same protective attachment may be used for cutter heads having only one row of cutting teeth and cutter heads having a pair of rows of cutting teeth.

When the cutter head has such two rows of cutting teeth facing away from each other and spaced apart from each other, the protective teeth along opposite frame legs of the ring-shaped attachment frame may be positioned along front sides of said two rows of cutting teeth. The attachment frame may be configured to extend around the shear foil system and around said two rows of cutting teeth, wherein the protective teeth are arranged front sides of said two rows of cutting teeth.

Furthermore, when the cutter head has such two rows of cutting teeth facing away from each other and spaced apart from each other, the cutter head as a whole may have a saddle roof-like or ridge roof-like configuration. More particularly, a first virtual plane contacting the shear foil system and a first one of said two rows of cutting teeth and a second virtual plane contacting the shear foil system and a second one of said two rows of cutting teeth may define such saddle roof-like or ridge roof-like configuration and may be inclined to each other at an obtuse angle.

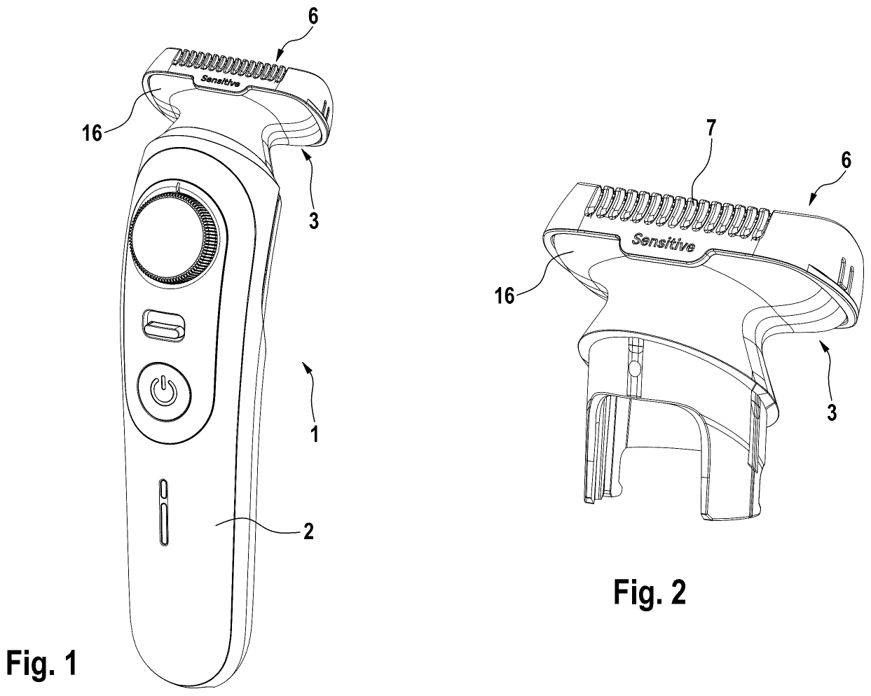

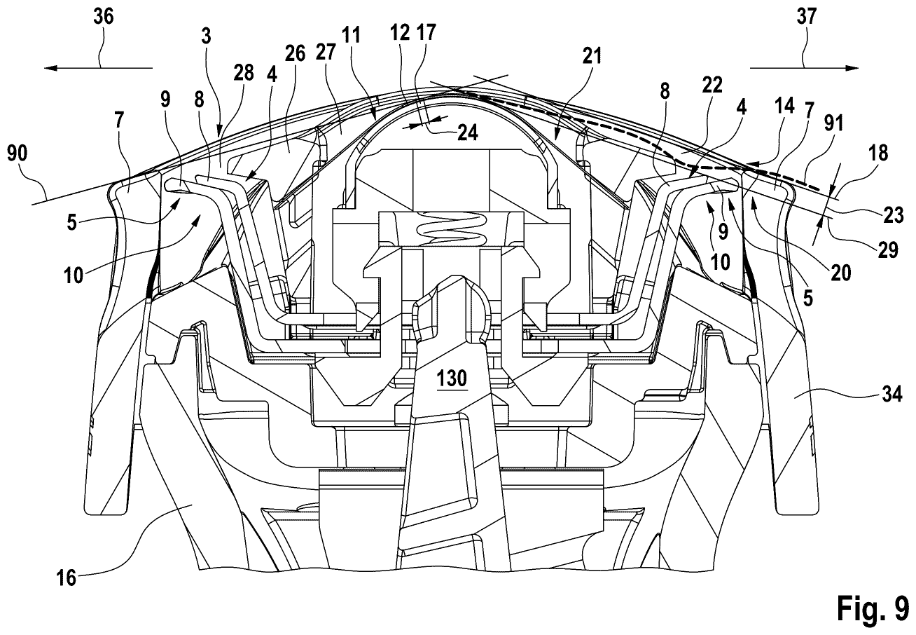

As can be seen from FIGS. 1 and 2, a cutter head 3 may be attached to a handle 2 of an electric body groomer or an intimate trimmer 1. More particularly, the groomer and/or trimmer 1 may include an elongated handle 2 accommodating the electronic and/or electric components such as a control unit, an electric or a magnetic drive motor and a drive train 130, cf. FIGS. 8 and 9, for transmitting the driving action of the motor to the cutter system 19 of the cutter head 3 which cutter head 3 may be positioned at one end of the elongated handle 2, cf. FIG. 1.

The elongated handle 2 may be straight or have a swan-necked or slightly cranked or angulate upper end portion in which said drive motor may be accommodated or at which said cutter head 3 is supported, which upper end portion may be cranked relative to a lower gripping portion at an acute angle. More particularly, the drive motor on the one hand and the control unit and/or a battery/accumulator for powering the drive motor 31 may be arranged in an angulate manner relative to each other in said swan-necked handle portions. Alternatively, said handle may be wider than longer.

The cutter system 19 includes a pair of cooperating cutter blades 4 and 5 and furthermore, a shear foil system 11, wherein, for example, the cutter system 19 may have at least one row 10 of cooperating rake-like cutting teeth 8, 9 which may be positioned along an edge portion of a shear foil cutter 12.

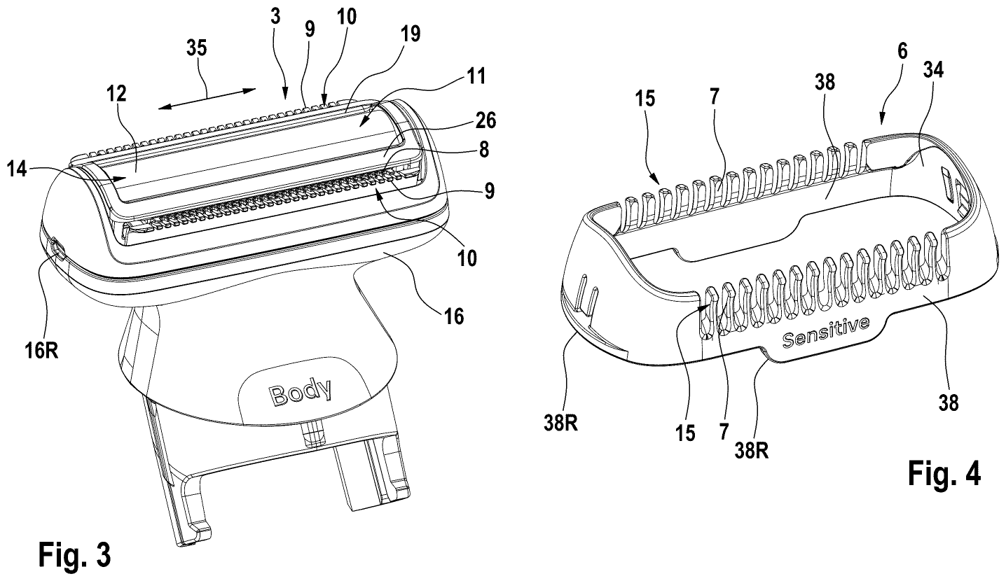

Said row 10 of cutting teeth may reciprocate relative to each other along a linear path 35, cf. FIG. 3, so as to effect the cutting action by closing the gaps between the teeth and passing over each other. On the other hand, the cutter system also might include cutting teeth aligned along a circle and/or are arranged radially. Such rotatory cutting elements may have cutting teeth projecting substantially radially, wherein the cutting elements may be driven to rotate relative to each other and/or to rotatorily oscillate relative to each other. The cutting action is basically similar to reciprocating cutting elements as the radially extending teeth, when rotating and/or rotatorily oscillating, cyclically close and reopen the gap between neighboring teeth and pass over each other like a scissor. Reciprocating relative to each other or rotating relative to each other may be achieved by reciprocating or rotating movements of both cutter blades, or by reciprocating or rotating movement of only one of said cutter blades with the other cutter blade being stationary and thus, not moving.

As illustrated by FIG. 9, it may be the upper one 4 of said pair of cutter blades 4, 5 which is driven, whereas the lower one 5 of said cooperating cutter blades 4, 5 may be stationary. A transmitter of the aforementioned drive train 130 may transmit the driving action to the upper cutter blade 4 to make the upper cutter blade 4 reciprocate.

The shear foil system 11 may include a shear foil cutter 12 comprising a perforated shear foil forming an upper cutter element and a lower cutter comprising a plurality of blade-like cutting shoulders in contact with and sliding on a lower or inner surface of the shear foil, cf. FIG. 9 illustrating one of the perforation 17 in the shear foil having a perforation diameter 24. As illustrated by FIG. 9, the shear foil cutter 12 may have a curved upper surface forming a cylindrical or elongated convex surface, cf. FIG. 3.

Similar to the reciprocating of the cutter blades, 4, 5 relative to each other, also the shear foil cutter 12 may be driven in a reciprocating manner, wherein it may be the lower cutter that is driven by the transmitter of the drive train 130 to reciprocate a long linear path 35. Thus, the reciprocating movements of the cutter blade 4, 5 on the one hand and of the shear foil cutter 12 on the other hand may be parallel to each other and/or parallel to a longitudinal axis of the cutter head 3, cf. FIG. 3.

As can be seen from FIGS. 3, 5 and 9, the upper surface of the shear foil system 11 may form a part of the skin contact surface 14 of the cutter head 3.

Also the outer or upper one 4 of said cutting elements 4, 5 may itself define a part of the skin contact surface 14 of the cutter head 3 at a forward end portion of the cutter head 3, when using the hair cutter 1 without protective attachment 6, cf. FIG. 3.

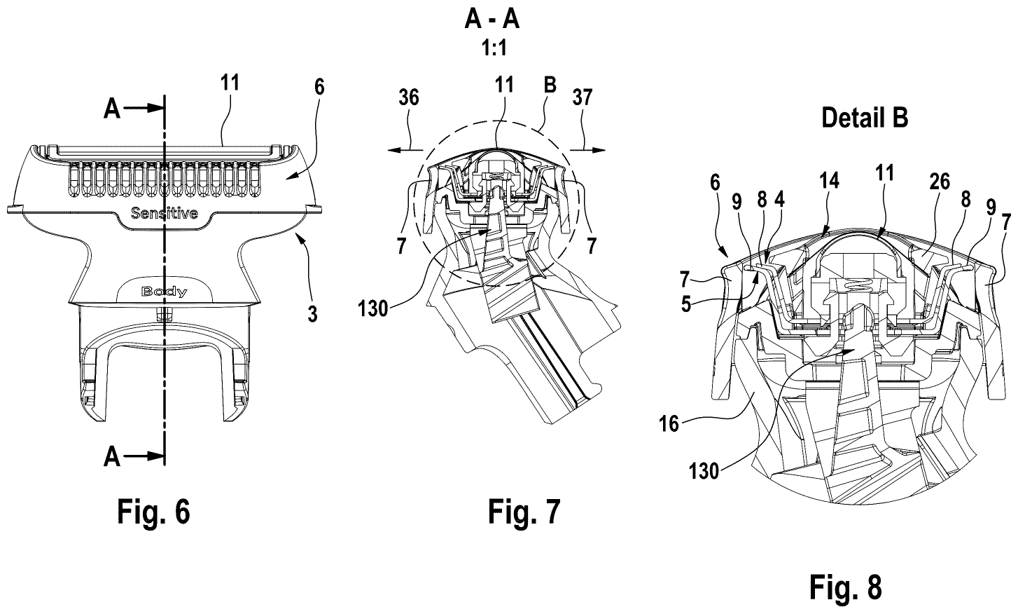

On the other hand, when the protective attachment 6 is attached to the cutter head 3, it is not the upper/outer cutting element 4 itself, but such protective attachment 6 which defines, together with the shear foil system 11 the skin contact surface 14 of the cutter system, cf. FIGS. 3 and 6.

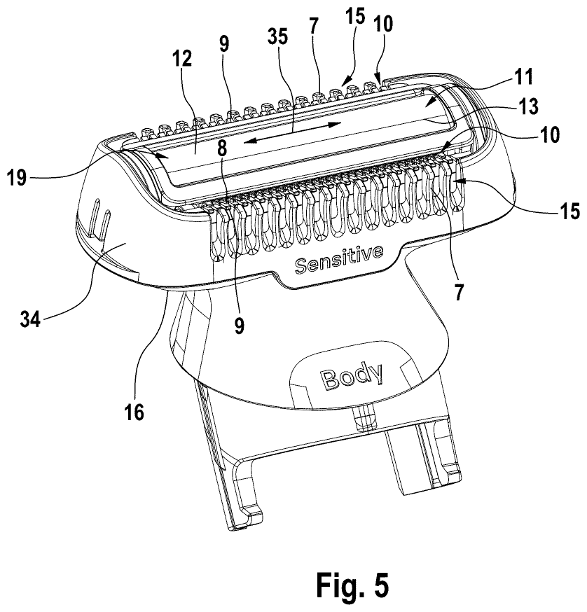

More particularly, the surface of the distance comb 6 facing away from the handle 2 or from the cutting elements 4, 5 may define the skin contact surface 14, cf. FIGS. 5, 8 and 9. Another part of the skin contact surface is still defined by the shear foil system 11 also when the protective attachment 6 is mounted.

As can be seen from FIGS. 3, 8 and 11 the cutter system 19 may include two rows 10 of cutting teeth 8, 9 which rows 10 are spaced apart from each other, wherein the shear foil system 11 is positioned in-between said two rows 10 of cutting teeth 8, 9. The cutting teeth 8, 9 of said two rows 10 are facing away from each other to allow for stroking the cutter head 3 over the skin in opposite stroking directions 36, 37, cf. FIGS. 7 and 9 showing such stroking directions 36 and 37.

As shown by FIG. 4, the protective attachment 6 may include a ring-shaped attachment frame 34 the shape of which is basically adapted to the outline of the cutter head 3. As the shear foil system 11 and the rows 10 of cutting teeth 8, 9 may have an elongated shape and may define a substantially rectangular cutter system 19, said attachment frame 34 may have a substantially rectangular, elongated configuration, cf. FIG. 4.

A pair of frame legs 38, which may form the longer sides of the attachment frame 34, may be provided with a row 15 of protective teeth 7 which may be aligned with each other and may have a shape or configuration identical to each other. When the protective attachment 6 is mounted onto the cutter head 3, said protective teeth 7 may be arranged along a front side of each of said row 10 of cutting teeth 8, 9, cf. FIGS. 5, 7, 8, 9, and 11, when considering said stroking directions 36 and 37.

Releasable attachment or snap-fitting elements 38R, 16R may be provided at the frame legs 38 or another portion of the attachment frame 34 on the one hand and/or at the cutter head frame 16 on the other hand to allow easy and releasable attachment of the protective attachment 6 to the cutter head 3, cf. FIGS. 3 and 4.

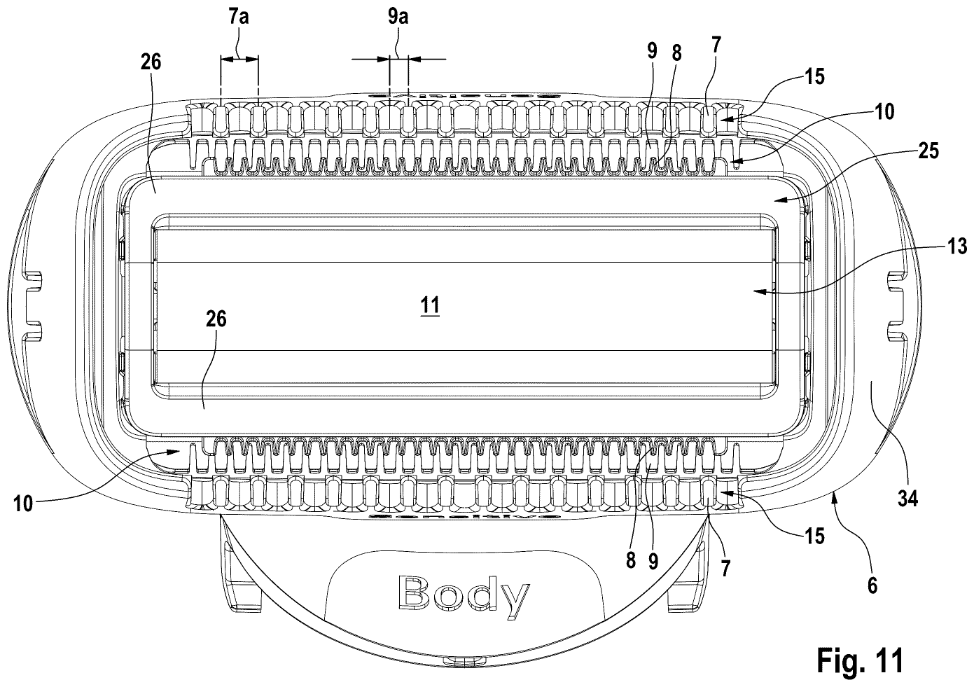

When considering a plane view substantially perpendicular onto the skin contact surface 14 of the cutter head 3, as it is shown by FIG. 11, the protective attachment 6 is adapted to the cutter head 3 such that a central cutter head region 25 including the shear foil system 11 and the two rows 10 of comb-like cutting teeth 8, 9 is left open and unobstructed by the protective attachment 6 so the skin has free access to the shear foil cutter system 11 from the top. The attachment frame 34 including the two rows 15 of protective teeth 7 extend only outside said central cutter head region 25 when considering the top view in a viewing direction substantially perpendicular onto the skin contact surface 14.

As mentioned, said rows 15 of protective teeth 7 are arranged on the front sides of the rows 10 of comb-like cutting teeth 8, 9, when considering the opposite stroking directions 36 and 37. So as to not block hairs from entering into the cutting zones of the cutter blades 4, 5 despite the protective teeth 7 being arranged on the front sides of the cutting teeth 8, 9, there are less protective teeth 7 than comb-like cutting teeth 8, 9. For example, the number of cutting teeth 8, 9 of cutter blades 4, 5 may be twice the number of protective teeth 7. Thus, the gaps between neighboring protective teeth 7 may be considerably larger than the gaps between neighboring teeth 8 or 9.

As can be seen from FIG. 11, the toothing pitch 7a of the protective teeth 7 may be an integer multiple of the toothing pitch 9a of the teeth 9 of the stationary cutter blade 5. For example, the toothing pitch 7a of the protective teeth 7 may be 200% of the toothing pitch 9a of the stationary cutting teeth 9.

Irrespective of the exact toothing pitch, the protective teeth 7 may be positioned exactly in front of one of the stationary cutting teeth 9, as it is shown by FIG. 11. Such a line positioning of the protective teeth 7 on the one hand and the stationary cutting teeth 9 on the other hand maximizes the width of the inner channels for the hairs entering into the cutting zone and, thus, makes the hairs reliably enter the cutting zone of the cooperating cutter blades 4, 5.

As can be seen from FIG. 9, the protective teeth 7, with their upper end side, define a plane 18 which is a virtual one and does not exactly correspond to the skin contact surface 14 of the cutter head 3 since, in a region between the protective teeth 7 and the shear foil system 11, the skin contact surface 14 shows a depression 22. In other words, the elements arranged between said upper end portions of the protective teeth 7 on the one hand and the shear foil system 11 on the hand are in a countersunk position or lowered relative to the virtual plane 18, cf. FIG. 9. The dotted line 91 shows an exemplary skin bulging with the protective attachment being attached to the cutter head. Thus, the skin follows the inclined skin contact surface of the top side of the teeth of the protective attachment, is then pushed into the depression towards the top side of the cutting teeth 8, 9 and then follows along line 29 or 90 towards the shear foil cutting system.

As can be seen from FIG. 9, said plane 18 is lying on the protective teeth and is parallel to a virtual plane 29 contacting at least the tips of one of the cutting teeth 8, 9 (of the moveable or non-moveable long hair cutter or both) and the shear foil system. Thus, this offset 23 between both parallel lines 29 and 18 creates a stubble trimming which is easily later shaved by the short hair cutting shear foils system as shorter hairs are more easily caught by a shear foil cutting system than longer hairs.

In particular, the comb-like cutting teeth 8, 9 of the cooperating cutter blades 4, 5 are in such countersunk position below said plane 18 contacting the protective teeth 7 so the skin, even then bulging towards the cutter head 3, does not directly contact the comb-like cutting teeth 8, 9, cf. FIG. 9 showing by a curved hatched line such skin bulging.

As illustrated by FIG. 9, the offset 23 of the cutting teeth 8, 9 from said plane 18 lying on the protective teeth 7 may be about 0.5 mm for example. More generally, such countersunk offset 23 may be substantially corresponding to or slightly smaller than the diameter 24 of the perforation 17 of the shear foil cutter system 11.

As illustrated by FIGS. 3, 5 and also 8 and 9, the skin contact brackets 26 may be formed on a rear side of the rows 10 of comb-like cutting teeth 8, 9 or, more generally, between said comb-like cutting teeth 8, 9 and the shear foil system 11. Such skin contact brackets 26 may have an elongated contour and/or may form ribs extending substantially parallel to said rows 10 of cutting teeth 8, 9. Such skin contact brackets 26 may form further parts of the skin contact surface 14, wherein such skin contact brackets 26 nevertheless may fulfil a double function since they may be used to hold or mount the shear foil of the shear foil cutter 12, cf. FIG. 9.

When considering the stroking directions 36 and 37, cf. FIG. 7, there may be concavities 28 and 27 on opposite sides of said skin contact bracket 26 wherein such concavities 27, 28 may form part of the aforementioned depression 22 of the skin contact surface 14. Thus, the upper surface of the skin contact bracket 26 forms part of the skin contact surface 14.

As can be seen from FIG. 9, such upper surface of the skin contact bracket 26 may be parallel to or may form part of said virtual plane 29 which is defined by contact to the shear foil system 11 on the one hand and the tooth tips of the cutting teeth 8, 9 on the other hand, cf. FIG. 9.

So as to make the cutter head 3 smoothly slide along the skin surface, the protective teeth 7 may have a rounded front edge 31 which is the protective teeth's edge facing away from the comb-like cutting teeth 8, 9.

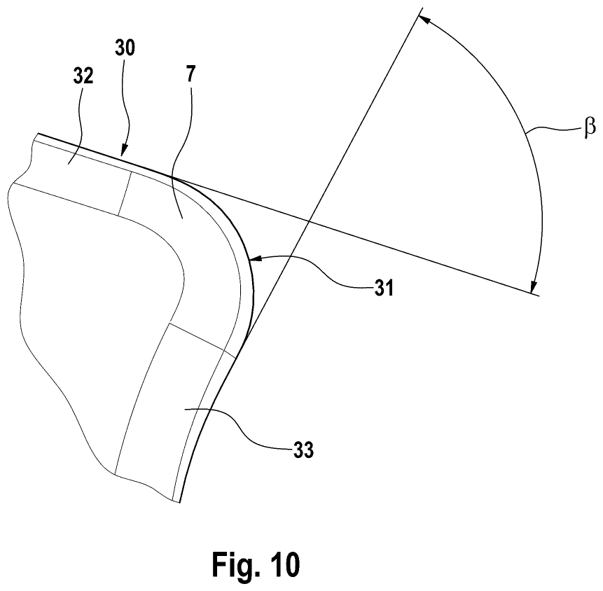

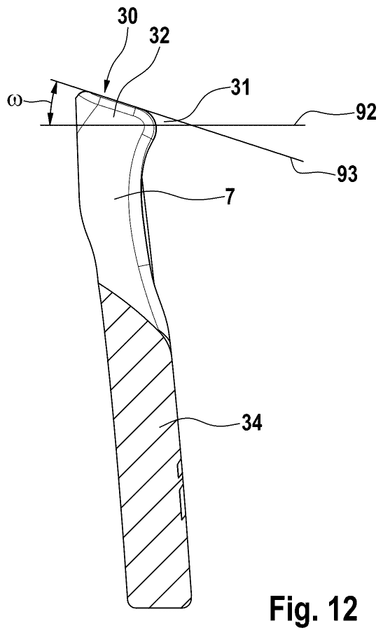

As illustrated by FIG. 10, said rounded front edge 31 connects the tooth flanks 32 and 33 to each other, wherein an upper one 32 of said tooth flanks 32, 33 forms the aforementioned top end surface 30 defining part of the skin contact surface 14. As shown with FIG. 12, each protective tooth of the protective attachment has a top end surface 30 which is inclined along line 93 relative to a horizontal line 92 by angle ó, said angle ranging from 10° to 35°. This optional inclination cases, forming the depression as the skin is guided upwards along its way to the shear foil. See also FIG. 9 and line 90 therein which connects the top end surface with a tangential to the shear foil and which basically coincides with line 93.

As illustrated by FIG. 10, said tooth flanks 32, 33 connected to each other by the rounded front edge 31 may be inclined relative to each other at an acute angle β, wherein such acute angle β may be about 80° or may range from about 75-85°.

As described above the intimate trimmer or body groomer comprises a handle 2, which allows it to exchange and attach different types of cutter heads 3 suitable for different trimming or shaving purposes. Said body groomer or intimate trimmer cutter head 3 comprise a cutting unit which may be exchanged and replaced by another one if the blades become blunt or worn out within the cutter head housing. This replaceable cutting unit comprises cooperating long hair trimmer cutter blades 4,5 at the opposite longer sides and a short hair cutting shear foil system 11 in-between. Other types of cutters and blade arrangements, e.g. without a short hair cutter and/or only one long hair cutter and/or a different sequence of its arrangement relative to each other and/or other functional units are alternatively used. Alternatively, the cutter head 3 with the cutter head frame 16 is not replaceably provided in favor of a more compact overall design and integral with the handle. Further alternative, the handle is not elongate, but wider than longer.

Thus, by the above described intimate trimmer, the long hair cutter blades first trim the hair to a stubble length of less than 1 mm and second the short hair cutting shear foil system can easily catch the stubble hairs, then cut or shave the hairs, so that no remaining stubbles are left over. For this purpose, the user simply has to glide the trimmer or body groomer over the skin in a slightly inclined way-along line 90, with the protective comb attachment 6 attached or along line 29 without protective attachment-by following the inclination of the skin contact surfaces and the roof like shape of one side of the cutter head 3.

In order to further protect sensitive very thin skin as provided in the human intimate area from being cut by the long hair trimmer blades 3,4 the user has to attach the protective comb attachment 6 which surrounds the cutter head cutting blades. The teeth of the protective comb attachment not only pre comb the hair, which improves the trimming efficiency but also avoids frontal contact with the trimming teeth, as otherwise thin skin could fold and bulge between such cutting teeth 8, 9 and would be cut. Non thin skin would not bulge between the teeth during usual operation. Further the teeth of the protective comb attachment elevate the skin contact level relative to the cutting teeth 8, 9 which are then located in a depression. Thus, the thin skin as provided in intimate areas-which is more easily prone to bulge-will still bulge close to the cutting teeth 8, 9, without being cut.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. Cutter head for an intimate trimmer or body groomer, comprising a cutter head frame attachable to an elongated handle, a pair of cooperating cutter blades each having at least one row of comb-like cutting teeth for long hair cutting and movable relative to each other, and a shear foil system with at least one field of perforations for short hair cutting arranged on a rear or trailing side of said at least one row of comb-like cutting teeth, and furthermore, a protective attachment for protecting skin from being cut by said comb-like cutting teeth, wherein said protective attachment includes a row of comb-like protective teeth arranged on a front side of said cutting teeth for long hair cutting opposite to said shear foil system on said rear or trailing side thereof, wherein said row of protective teeth and said shear foil system together form parts of a skin contact surface of the cutter head, wherein said skin contact surface provides for a depression for skin bulging between said row of protective teeth and said shear foil system, wherein said row of cutting teeth for long hair cutting is arranged in said depression.

2. Cutter head according to claim 1, wherein said comb-like protective teeth of said protective attachment project beyond and are elevated vis-à-vis a virtual plane lying onto said shear foil system and at least one of the tips of said cutting teeth by a distance ranging from about 25% to about 125% or about 33% to about 100% or about 50% to about 95% of a diameter of perforations of said shear foil system or by a distance a distance within the range from about 0.1 to about 0.6 mm or from about 0.2 to about 0.5 mm or from about 0.3 to about 0.5 mm.

3. Cutter head according to claim 1, wherein said shear foil system has a convex, barrel-like or extrusion-like skin contacting contour forming part of the skin contact surface of the cutter head, wherein said skin contact surface is provided with at least one elongated or channel-like deepening between said convex skin contacting contour of the shear foil system and said row of protective teeth.

4. Cutter head according to claim 1, wherein a toothing pitch of the protective teeth is an integer multiple of a toothing pitch of the cutting teeth, or the protective teeth are arranged such that a protective tooth is arranged in front of every second or every third stationary cutting tooth.

5. Cutter head according to claim 1, wherein a.) said protective attachment is formed exclusively outside a central cutter head region in which at least said shear foil system or said shear foil system plus said at least one row of cutting teeth is arranged so, when considering a viewing direction perpendicular onto said virtual tangential plane, at least said shear foil system or said shear foil system plus the cutting teeth are left unobstructed by said protective attachment, or b.) wherein said protective attachment is arranged only at the lateral sides of said shear foil system plus said at least one row of cutting teeth, so that the protective attachment is framing the shear foil system plus the at least one row of cutting teeth.

6. Cutter head according to claim 1, wherein a skin contact bracket is provided between said shear foil system and said row of cutting teeth.

7. Cutter head according to claim 6, wherein said skin contact bracket forms a part of the skin contact surface of the cutter head which part of the skin contact surface formed by the skin contact bracket is tangential to or adjacent to a/the virtual plane onto said shear foil system and said row of cutting teeth, wherein a deepening is provided between said skin contact bracket and said shear foil system and a another deepening is provided between said skin contact bracket and said row of cutting teeth.

8. Cutter head according to claim 1, wherein the protective teeth have a substantially planar top end surface for contacting skin that is inclined relative to a horizontal line by about 5° to about 40° or by about 10° to about 30°.

9. Cutter head according to claim 1, wherein said protective teeth have an outer rounded edge facing away from said row of cutting teeth and connecting tooth flanks which are inclined to each other at an acute angle β.

10. Cutter head according to claim 9, wherein said acute angle β ranges from about 60° to about 90° or from about 70° to about 89° or from about 75° to about 85°.

11. Cutter head according to claim 1, wherein one of said cutter blades is a stationary cutter blade and the other one of said cutter blades is a movable or reciprocating cutter blade, wherein said movable or reciprocating cutter blade is an upper cutter blade closer to said virtual tangential plane to the shear foil system and the row of protective teeth than said stationary cutter blade.

12. Cutter head according to claim 1, wherein said protective attachment is releasably attached to or snap-fitted with said cutter head frame.

13. Cutter head according to claim 1, wherein two rows of cutting teeth are provided, said rows of cutting teeth facing away from each other and positioned on opposite sides of said shear foil system, wherein said protective attachment includes a ring-shaped attachment frame which is provided with two rows of protective teeth along opposite frame legs, wherein said attachment frame is configured to extend around said shear foil system and said two rows of cutting teeth with said two rows of protective teeth being arranged along front sides of said rows of cutting teeth.

14. Hair cutter according to claim 1, for cutting hair in sensitive or intimate body regions, comprising an elongated handle and a cutter head attachable to said handle.
